(19) United States
(12) Patent Application Publication
(10) Pub. No.: US 2011/0091179 A1
(43) Pub. Date: Apr. 21, 2011

(54) SPLICE HOLDER

(75) Inventor: Pia Kopf, Berlin (DE)

(73) Assignee: ADC GmbH, Berlin (DE)

(21) Appl. No.: 12/886,880

(22) Filed: Sep. 21, 2010

(30) Foreign Application Priority Data
Oct. 19, 2009 (DE) 10 2009 049 876.1

(51) Int. Cl. G02B 6/00

(52) U.S. Cl. 385/135

(57) ABSTRACT

The invention relates to a splice holder (1), comprising at least one splice retainer (3) having at least two contact surfaces (4), a common spring element (5) being arranged offset laterally in relation thereto, by means of which at least one splice (16, 17) can be pressed against the two contact surfaces (4) in a sprung manner.

This application claims benefit of Serial No. 10 2009 049 876.1, filed 19 Oct. 2009 in Germany and which application is incorporated herein by reference. To the extent appropriate, a claim of priority is made to the above disclosed application.

### BACKGROUND

The invention relates to a splice holder having at least one splice retainer.

Splice holders and splice retainers are used to hold splices mechanically, such as crimp, heat-shrink or mechanical splices or else optical splitters. The number of splice retainers per splice holder depends on the application. The splice retainers typically comprise one or two contact surfaces, two spring elements being arranged offset laterally in relation thereto and then pressing the splice against the contact surface in a sprung manner. On account of the very small dimensions, the insertion of the splices is relatively complicated.

### SUMMARY

The invention is based on the technical problem of devising a splice holder by means of which the insertion operation is simplified.

For this purpose, the splice holder comprises at least one splice retainer having at least two contact surfaces, a common spring element being arranged offset laterally in relation thereto, by means of which at least one splice can be pressed against the two contact surfaces in a sprung manner. This achieves the situation where only one spring element has to be moved as the splice is inserted, a secure three-point mounting nevertheless being achieved. By means of the two contact surfaces, it is also ensured that the spring element is easily accessible through the interspace. The splice holder is preferably made of plastic. The splice holder is also preferably formed as a separate component or else can also be formed as an integrated injection moulding belonging to a housing.

In one preferred embodiment, the common spring element is attached to the splice holder on only one side. As a result, it is also possible to compensate well for even relatively large dimensional differences between the splices to be inserted.

In a further preferred embodiment, the splice holder has at least two splice retainers, the spring elements of adjacent splice retainers being attached to opposite sides of the splice holder. This likewise simplifies the insertion of the splices.

In a further preferred embodiment, the spring element is, at least to some extent, higher than the contact surface. In this way, the spring element can easily be bent away with the splice during insertion, which likewise makes the insertion operation simpler.

In a further preferred embodiment, the spring element is curved twice in the direction of the contact surfaces, so that two pressure points for an upper and lower splice are formed. In this case, the pressure points can have a different spacing from the contact surface. As a result, tolerances can be absorbed from the upper and lower splice. Here, the pressure point for the upper splice can have a smaller spacing or larger spacing than the pressure point for the lower splice. In this case, the spacing is the normal vector from the pressure point to a virtual plane through the two contact surfaces. Also preferably, the spring element in the region of the pressure point for the upper splice is higher than the contact surfaces.

In a further preferred embodiment, a hold-down is arranged on the upper side of the spring element, above the pressure point for an upper splice.

In a further preferred embodiment, on the non-attached end of the spring element, there are arranged lateral guide webs and upper guide hooks, which delimit the upper and lateral spring travel. In this case, the upper guide hooks can be configured in such a way that, when the spring element is unloaded, they do not protrude beyond the spring element.

In a further preferred embodiment, underneath the spring element, on the splice holder, there is arranged at least one projection, which stops the spring element being pressed down. Preferably, at least two projections are provided for each spring element, also preferably at least one being arranged in the region of the free end and one being arranged centrally. The projections in each case preferably symmetrically narrow a slot in a baseplate of the splice holder.

### BRIEF DESCRIPTION OF THE DRAWINGS

The invention will be explained in more detail below by using a preferred exemplary embodiment. In the figures:

FIG. 1 shows a perspective plan view of a splice holder,

FIG. 2 shows a perspective bottom view of the splice holder,

FIG. 3 shows a bottom view of the splice holder,

FIG. 4 shows a side view of the splice holder,

FIG. 5 shows a plan view of the splice holder,

FIG. 6 shows a front view of the splice holder,

FIG. 7 shows a perspective plan view of the splice holder with a splice inserted, and

FIG. 8 shows a perspective plan view of the splice holder with two splices inserted.

### DETAILED DESCRIPTION

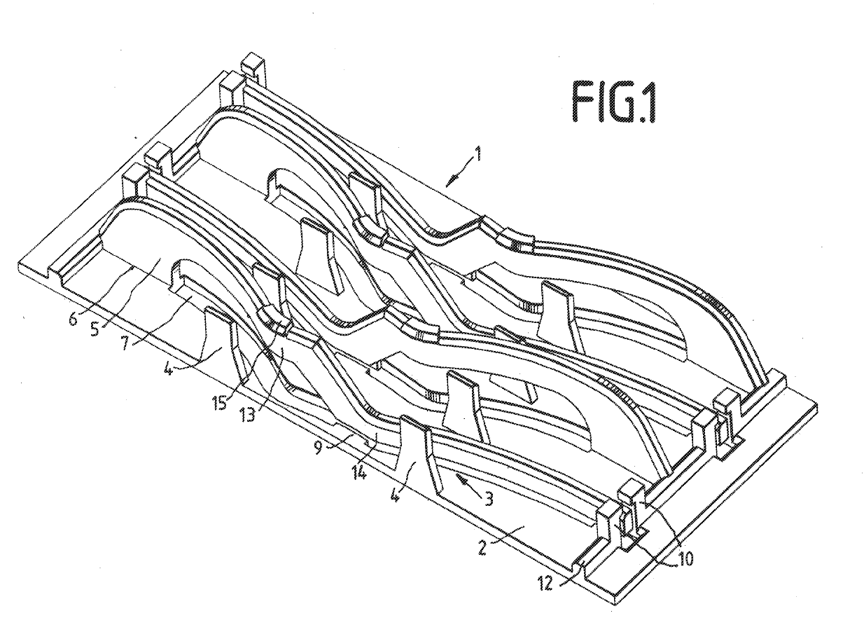

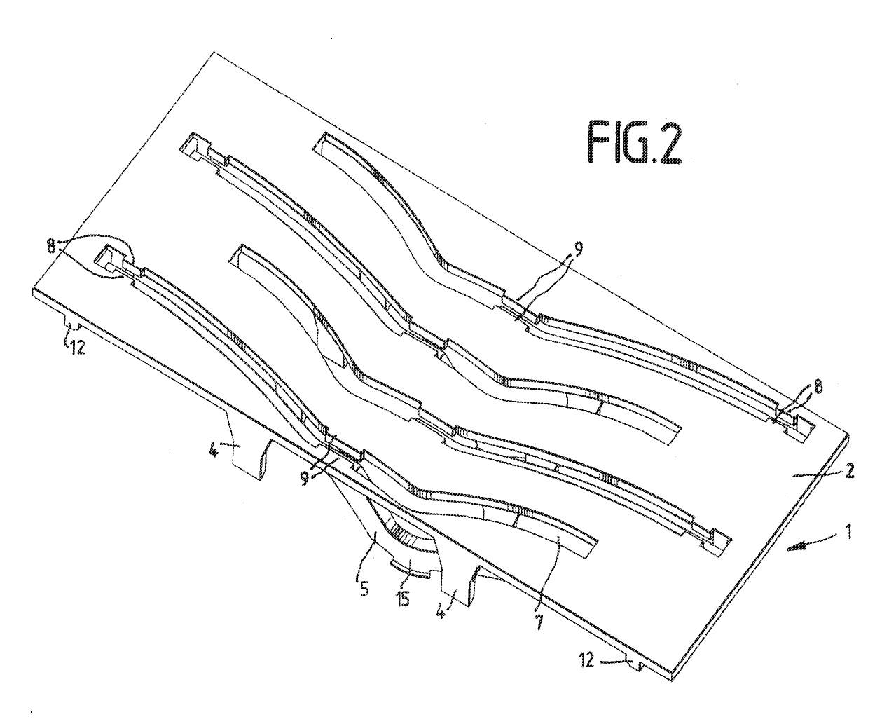

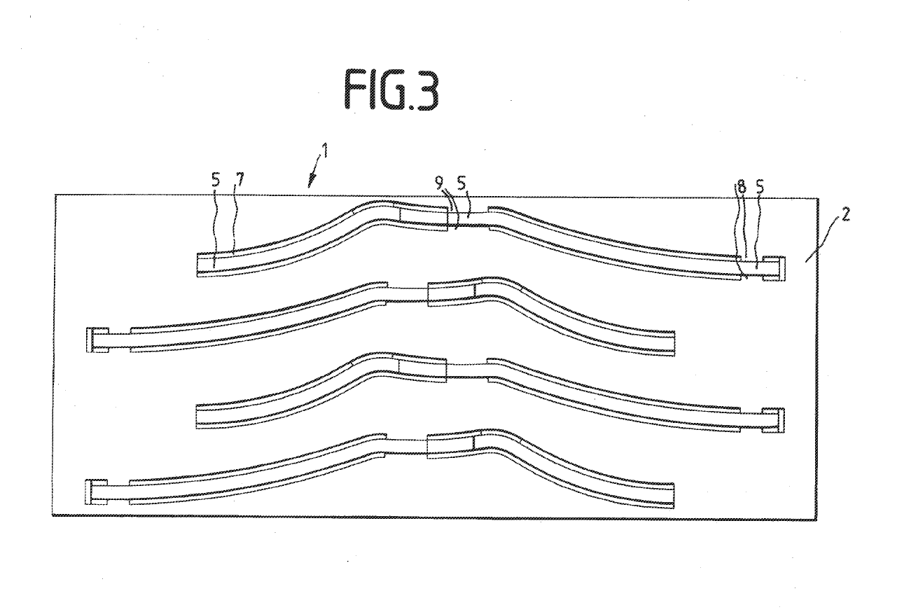

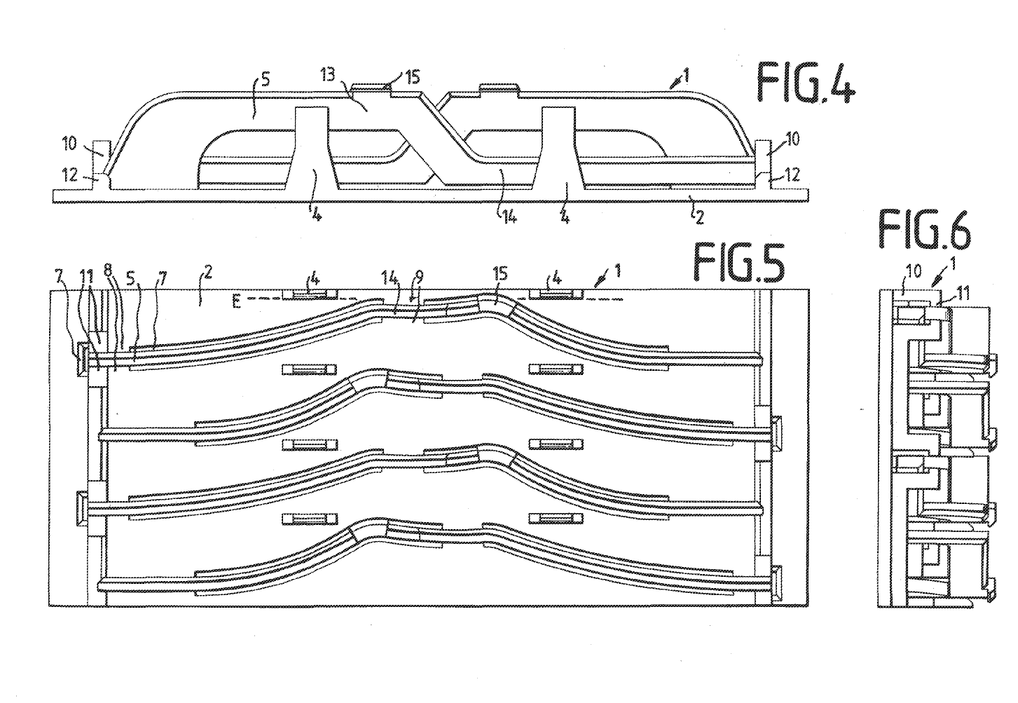

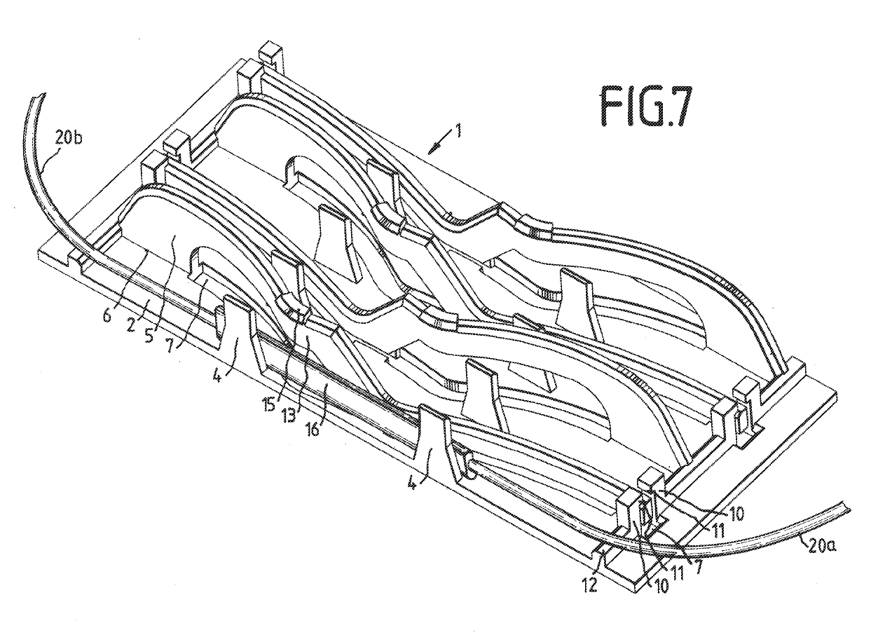

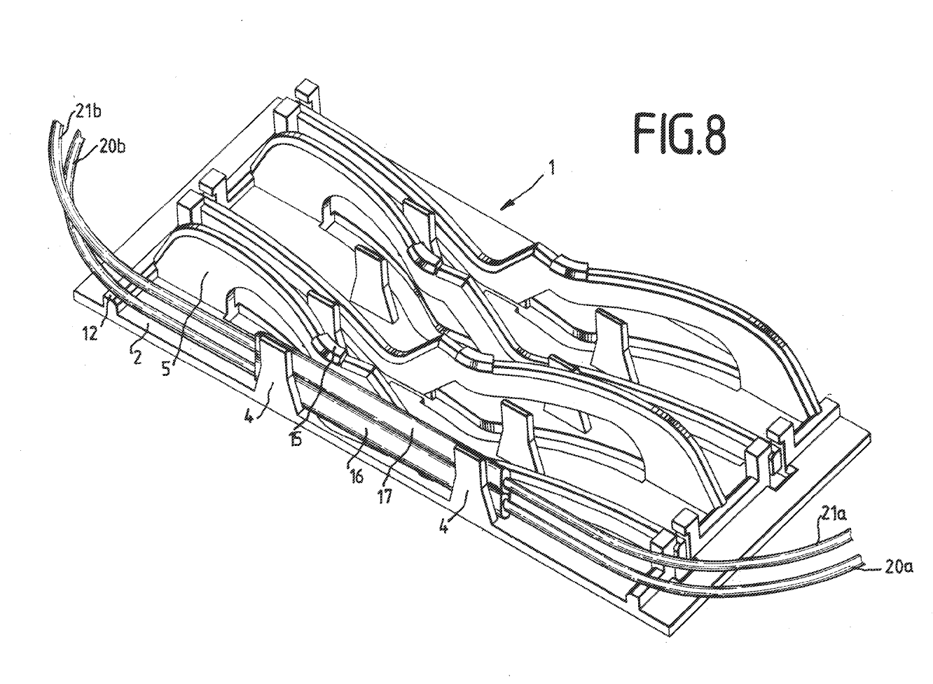

In FIG. 1, the splice holder 1 is shown perspectively. The splice holder 1 comprises a baseplate 2, on which four splice retainers 3 are arranged. Each splice retainer 3 comprises two contact surfaces 4, a spring element 5 being arranged offset laterally in relation thereto. Each splice retainer 3 is designed in such a way that it is able to hold two splices, which will be explained in more detail later. Here, the front spring element 5 is attached to the baseplate 2 on the left-hand side LS. The attachment 6 extends over a certain length, in order to ensure adequate stability. On the right-hand side RS located opposite the attachment 6, the spring element 5 is not attached. Underneath the spring element 5, in the baseplate 2, there is a slot 7, the course of which corresponds largely to the lateral curvature of the spring element 5. This will also be explained in more detail below. The splice retainer 3 arranged behind the foremost splice retainer 3 has a rotated spring element 5, that is to say the spring element 5 has its attachment 6 on the right-hand side RS. In a corresponding way, the spring element of the next splice retainer 3 once more has its attachment 6 on the left-hand side LS. Furthermore, for each slot 7, the baseplate 2 has two symmetrical projections 8, 9, which narrow the slot 7 in some sections and in this way stop the spring element 5 being pressed down. Here, the projection 8 is arranged in the region of the free end of the spring element 5, and the projection 9 is arranged approximately centrally. The projections 8, 9 can be seen particularly well in FIGS. 2 and 3. At the free end of the spring element there are arranged two lateral guide webs 10, from the upper side of which there originate guide hooks 11, which is illustrated in particular in FIG. 6. Furthermore, the splice holder 1 has transverse ribs 12, which firstly reinforce the splice holder 1 and prevent longitudinal displacement of the splices. The spring element 5 is bent laterally twice, so that a pressure point 13 (or pressure line) for an upper splice 17 (see FIG. 8) and a pressure point 14 for a lower splice 16 (see FIG. 7) are formed. Above the pressure point 13 for the upper splice 17, the spring element 5 has a hold-down 15 for the upper splice 17. Here, the pressure point 13 for the upper splice 17 is located closer to a virtual plane E (see FIG. 5) which goes through the two contact surfaces 4, the pressure point 13 being concealed by the hold-down 15 in FIG. 5. In the region of the pressure point 13 for the upper splice 17, the spring element 5 is higher than the contact surfaces 4 and, in the region of the pressure point 14 for the lower splice 16, is lower than the contact surfaces 4 (see FIG. 4). Therefore, when a splice is inserted, the latter can be guided over the contact surfaces 4 and pressed laterally against the spring element 5, in order to make the insertion operation easier.

FIG. 7 shows how a lower splice 16 with glass fibers 20a, 20b is inserted into the front splice retainer 3. The splice 16 is clamped in between the two contact surfaces 4 and the pressure point 14. On account of the geometry of the spring element 5, a part 15 of the spring element 5 is located above the lower splice 16, and thus acts as a hold-down for the lower splice 16. FIG. 8 then illustrates the situation in which an upper splice 17 with glass fibers 21a, 21b is additionally inserted and is then clamped in between the upper pressure point 13 and the two contact surfaces 4.

In the case of the foremost splice retainer 3, the upper pressure point 13 is arranged more toward the left-hand side LS and the lower pressure point 14 is arranged more toward the right-hand side RS. On the other hand, in the case of the next splice retainer 3 located behind it and having the attachment on the right-hand side RS, the upper pressure point 13 is arranged more toward the right-hand side RS and the lower pressure point is arranged more toward the left-hand side LS.

### LIST OF DESIGNATIONS

1 Splice holder
2 Baseplate
3 Splice retainer
4 Contact surfaces
5 Spring element
6 Attachment
7 Slot
8, 9 Projections
10 Guide webs
11 Upper guide hooks
12 Transverse ribs
13, 14 Pressure point
15 Hold-down
16 Lower splice
17 Upper splice
20a, 20b Glass fibers
21a, 21b Glass fibers
LS Left-hand side
RS Right-hand side

1. A splice holder, comprising at least one splice retainer having at least two contact surfaces, a common spring element being arranged offset laterally in relation thereto, wherein at least one splice can be pressed against the two contact surfaces in a sprung manner.

2. The splice holder as claimed in claim 1, wherein the common spring element is attached to the splice holder on only one side.

3. The splice holder as claimed in claim 1, wherein the splice holder has at least two splice retainers, the spring elements of adjacent splice retainers being attached to opposite sides of the splice holder.

4. The splice holder as claimed in claim 1, wherein the spring element is, at least to some extent, higher than the contact surfaces.

5. The splice holder as claimed claim 1, wherein the spring element is curved twice in the direction of the contact surfaces, so that two pressure points for an upper and a lower splice are formed, the pressure point for the upper splice being curved further or closer or equally in the direction of the contact surfaces as compared with the pressure point for the lower splice.

6. The splice holder as claimed in claim 5, wherein a hold-down is arranged on the upper side of the spring element, above the pressure point for an upper splice.

7. The splice holder as claimed in claim 2, wherein, on the non-attached end of the spring element, there are arranged lateral guide webs having upper guide hooks.

8. The splice holder as claimed in claim 1, wherein, underneath the spring element, on the baseplate, there is arranged at least one projection, which stops the spring element being pressed down.
